(19) United States
(12) Patent Application Publication
(10) Pub. No.: US 2014/0305551 A1
(43) Pub. Date: Oct. 16, 2014

(54) COPPER ALLOY MATERIAL FOR ELECTRICAL AND ELECTRONIC COMPONENTS AND METHOD OF PREPARING THE SAME

(71) Applicants: CHEOL MIN PARK, Daejeon (KR); In Youb Hwang, Ulsan (KR)

(72) Inventors: CHEOL MIN PARK, Daejeon (KR); In Youb Hwang, Ulsan (KR)

(73) Assignee: POONGSAN CORPORATION, Seoul (KR)

(21) Appl. No.: 14/059,633

(22) Filed: Oct. 22, 2013

(30) Foreign Application Priority Data
Nov. 9, 2012 (KR) 10-2012-0126595

(51) Int. Cl. C22F 1/08; H01B 1/02

(52) U.S. Cl. CPC C22F 1/08; H01B 1/026
USPC 148/554; 148/435; 148/414; 148/434; 148/433

(57) ABSTRACT

A copper alloy material for electrical and electronic components and a method of preparing the same are disclosed. In particular, a copper alloy material with excellent mechanical strength characteristics, high electrical conductivity, and high thermal stability as a material for information transmission and electrical contact of connectors or the like for home appliances and automobiles, including semiconductor lead frames and a method of preparing the same are disclosed.

### CROSS REFERENCE TO RELATED APPLICATIONS

This application claims the benefit of Korean Patent Application No. 10-2012-0126595, filed on Nov. 9, 2012, which is hereby incorporated fully by reference.

### FIGURE SELECTED FOR PUBLICATION

FIG. 1B

### BACKGROUND OF THE INVENTION

1. Field of the Invention

The present invention relates to a copper alloy material for electrical and electronic components and a method of preparing the same and, more particularly, to a copper alloy material with excellent mechanical strength characteristics, high electrical conductivity, and high thermal stability as a material for information transmission and electrical contact of connectors or the like for home appliances and automobiles, including semiconductor lead frames and a method of preparing the same.

2. Discussion of the Related Art

As materials for electrical/electronic components such as semiconductor lead frames, connectors, and the like, in general, precipitation hardening-type copper (Cu) alloy materials are mainly used. Among such copper alloy materials, Corson (Cu—Ni—Si)-based copper alloy materials have high strength and excellent electrical conductivity and thus are used in a variety of applications, but such materials require very stringent management of impurities (i.e., 300 to 500 ppm) to achieve high electrical conductivity.

As is known, Cu is an excellent conductor of electricity and has been widely used from ancient times. However, pure Cu has weak strength and thus is not suitable for use as a component requiring high strength. Thus, research on materials with high strength through fabrication of alloys by adding various alloy elements to Cu has been underway in many nations such as the United States, Japan, etc.

However, copper alloy materials such as general brass or bronze fabricated through solid-solution strengthening or work hardening using alloy elements may have higher strength than that of pure Cu, due to addition of alloy elements, but have a significantly lower electrical conductivity than that of pure Cu. Thus, such copper alloy materials are not suitable for use as materials for electrical/electronic components requiring both high strength and high electrical conductivity, such as transistors, lead frames of integrated circuits and the like, electrical accessories, or the like.

In precipitation hardening-type Corson-based copper alloys that have been developed to date, Ni and Si included therein in a certain ratio are main elements representing precipitation hardening.

Conventionally, to enhance strength characteristics within a range of minimizing reduction in electrical conductivity, there have been efforts that add a very small amount of alloy elements such as magnesium (Mg), iron (Fe), phosphorus (P), tin (Sn), cobalt (Co), chromium (Cr), manganese (Mn), zinc (Zn), titanium (Ti), and the like, in addition to Ni and Si. Among these alloy elements, in particular, Mg undergoes small reduction in electrical conductivity and has an excellent solid-solution strengthening effect, excellent stress-relieving performance, and high thermal stability when manufacturing lead frames, and thus, has been adopted and used as a main alloy element. In practical operation, however, strong oxidative strength of Mg incurs formation of oxides and reduces fluidity of molten metal in casting and thus problems, such as occurrence of surface defects or deep wrinkles of an ingot and rolling of the formed oxides into the ingot or formation of micropores in the ingot, occur in practice, and surface cracking occurs in hot rolling and surface defects occur when fabricating a strip through cold rolling, which remain problematic. In addition, the alloy elements such as P, Sn, Mn, and Ti have an excellent solid-solution strengthening effect, but significantly reduce electrical conductivity of the fabricated copper alloy material even when the alloy elements are added in small amounts, and thus, it is necessary to use very small amounts of these alloy elements even though the alloy elements are main alloy elements.

To address these existing problems, inventions have recently been disclosed wherein the size of precipitates can be controlled by optimization of Ni, Si, and other added alloy elements to secure quality thereof and when other alloy elements are added, a composition ratio thereof is appropriately adjusted according to a degree of reduction in electrical conductivity, whereby alloy properties are enhanced. However, a total amount of impurity elements, which may considerably reduce electrical conductivity when added, such as Ti, Co, Fe, arsenic (As), Mn, germanium (Ge), Cr, niobium (Nb), antimony (Sb), aluminum (Al), Sn, and the like, still has to be stringently restricted (See Korean Patent Registration Nos.: 10-0679913, 10-0403187, and 10-0674396), the contents of each of which are incorporated fully herein by reference.

With regards to the above description, reduction in electrical conductivity according to addition of alloy elements to Cu is disclosed in a reference document (See [Niedriglegierte Kupferlegierungen, Deutsche Kupfer Institut, p. 22], the contents of which is incorporated herein fully by reference). For example, the reference document discloses that alloy elements such as silver (Ag), oxygen (O), Zn, and the like cause relatively little decrease in electrical conductivity according to amounts thereof added, while alloy elements such as Ti, Co, Fe, Mn, Ge, Cr, Nb, Sb, Al, Sn, and the like cause considerable reduction in electrical conductivity.

According to related art, introduction of P into Cu alloys mainly causes deoxidation effects and also enables fluidity of molten metal to be secured, whereby castability is enhanced. In addition, a method of alloying pure copper in small amounts is used to prevent hydrogen embrittlement.

Phosphorus deoxidized copper, which is widely used in industries, is a Cu alloy prepared such that pure copper is deoxidized with P to minimize oxygen present therein and a residue allowable amount of P is between 200 and 500 ppm, and the electrical conductivity thereof is decreased by 80 to 85% with respect to pure copper. In addition, in this case, when other alloy elements are included as impurities, the electrical conductivity of the Cu alloy is very dramatically reduced. For example, when an element such as Ti or Co is included only in an amount of 100 ppm, the electrical conductivity of the Cu alloy is significantly reduced.

Meanwhile, there are some documents reporting effects of phosphorus addition in such precipitation hardening-type Corson (Cu—Ni—Si)-based Cu alloys, but all the documents disclose only phosphorus addition effects through precipitates in the form of intermetallic compounds with main components. That is, it has been confirmed that Ni combines with P to form Ni₃P or Ni₅P₂ and Fe combines with P to form Fe₃P or the like and thus the compounds play a crucial role in increasing strength and electrical conductivity of the formed Cu alloys (Korean Patent Registration No.: 10-0018127, the entire contents of which are incorporated herein fully by reference), and P combines with Mg to form a compound in the form of Mg₃P₂ or MgP₄, whereby the compound plays a role in enhancing a strengthening effect and increasing thermal stability in a molding process in packaging of integrated circuits of semiconductor lead frames (Korean Patent Registration No.: 10-0082046, the entire contents of which are incorporated herein fully by reference).

However, there is no report that P added in the prior art acts as a precipitation mediator between alloy elements and transition metal impurities to form a third intermetallic compound, whereby reduction in electrical conductivity due to transition metal impurities is suppressed and electrical conductivity is rather increased.

### SUMMARY OF THE INVENTION

Accordingly, the present invention is directed to a copper alloy material for electrical and electronic components and a method of preparing the same that substantially obviate one or more problems due to limitations and disadvantages of the related art.

An object of the present invention is to provide a copper alloy material for electrical and electronic components which includes an impurity component and exhibits high strength, high thermal stability, and high electrical conductivity and a method of preparing the same.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a copper (Cu) alloy material for electrical and electronic components includes 0.5 to 4.0 wt % of nickel (Ni), 0.1 to 1.0 wt % of silicon (Si), 0.02 to 0.2 wt % of phosphorus (P), the remainder of Cu, and an inevitable impurity. The inevitable impurity may include at least one transition metal selected from the group consisting of titanium (Ti), cobalt (Co), iron (Fe), manganese (Mn), chromium (Cr), niobium (Nb), vanadium (V), zirconium (Zr), and hafnium (Hf), wherein the at least one transition metal chemically combines with a Ni—Si—P-based precipitate using P as a mediator to form a compound in the form of Ni—Si—P—X (wherein, X is the transition metal). A total amount of the inevitable impurity may be within 10% of the sum of amounts of Ni and Si of the Cu alloy material.

The Cu alloy material may further include 0.3 wt % or less of magnesium (Mg), 0.3 wt % or less of silver (Ag), 1.0 wt % or less of zinc (Zn), or 0.8 wt % or less of tin (Sn). A precipitate in the Cu alloy material may have a size of 1 μm or less.

In another aspect of the present invention, a method of preparing a Cu alloy material includes obtaining an ingot through melting and casting so as to have composition of 0.5 to 4.0 wt % of Ni, 0.1 to 1.0 wt % of Si, 0.02 to 0.2 wt % of P, the remainder of Cu, and an inevitable impurity, hot-working the ingot at a temperature between 750 and 1050° C. and water-cooling the hot-worked ingot, cold-working the product obtained through the hot-working to a desired thickness and repeatedly annealing and air-cooling the cold-worked product at a temperature between 300 and 600° C. for 1 to 15 hours, and continuously stress removal heat-treating the product obtained through the cold-working at a temperature between 300 and 700° C. for 10 to 600 seconds. In the melting process, 0.3 wt % or less of Mg, 0.3 wt % or less of Ag, 1.0 wt % or less of Zn, or 0.8 wt % or less of Sn may be further added. A precipitate formed in the Cu alloy material prepared using the above-described preparation method may have a size of 1 μm or less.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

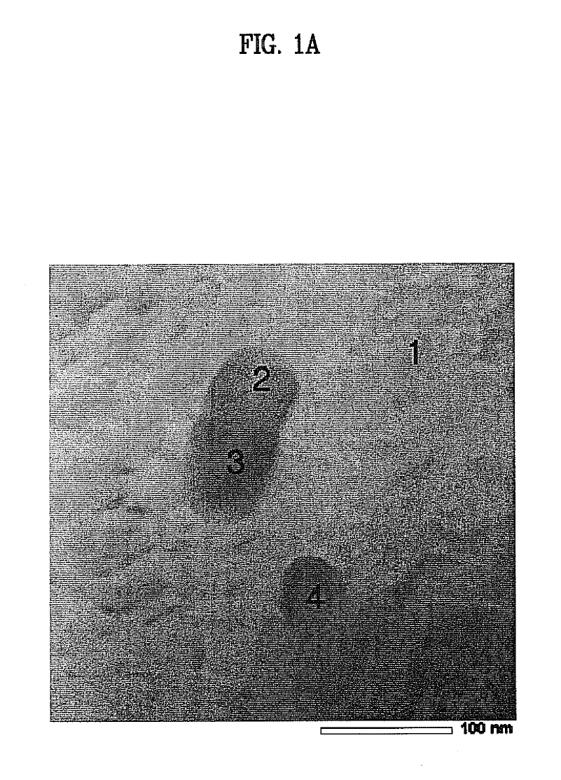

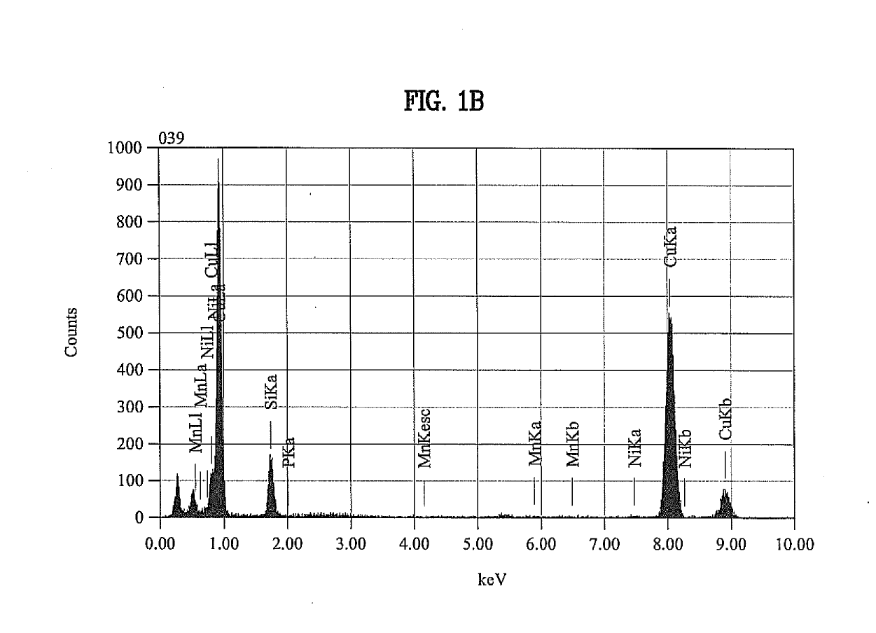

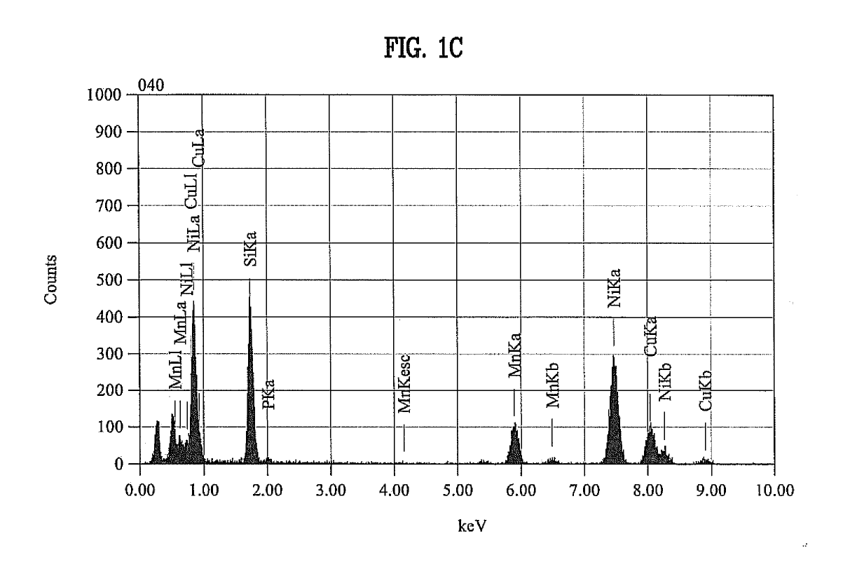

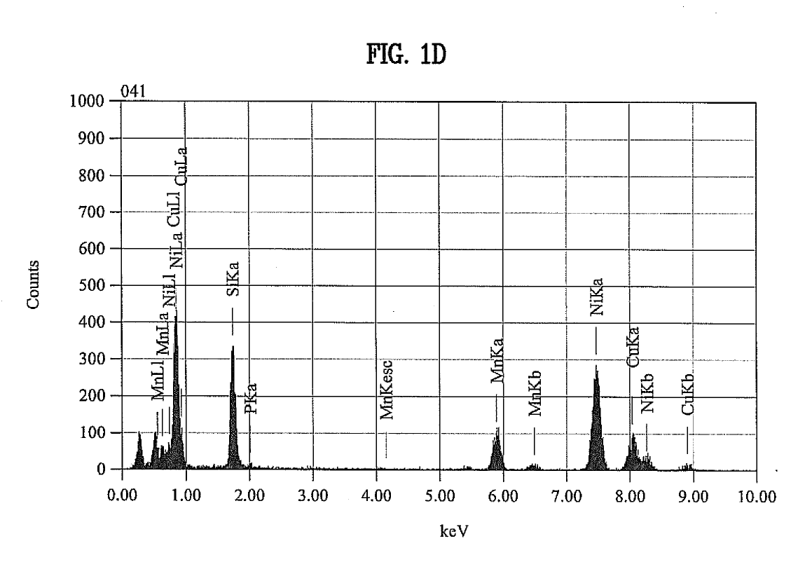

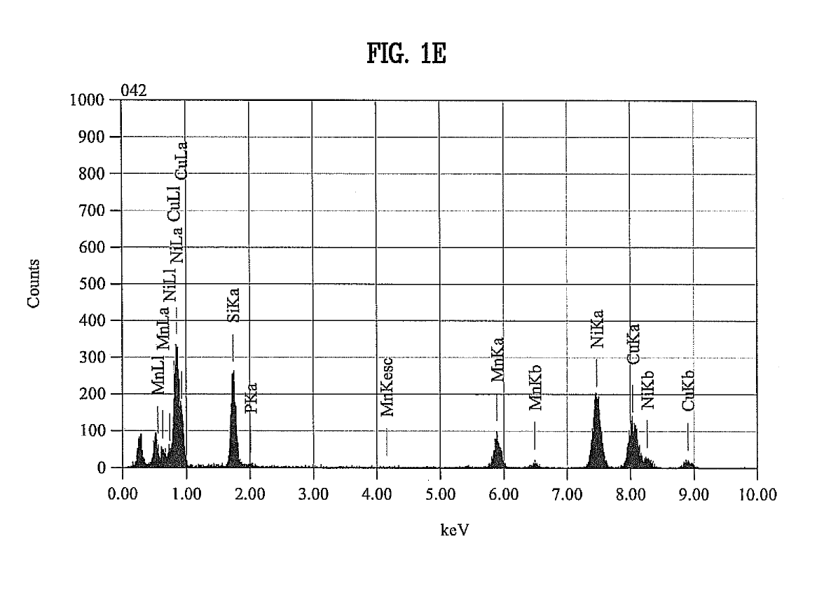

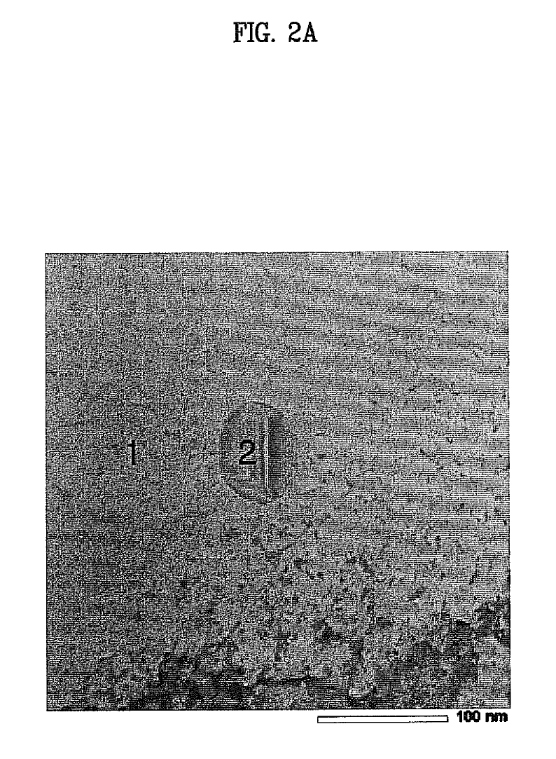

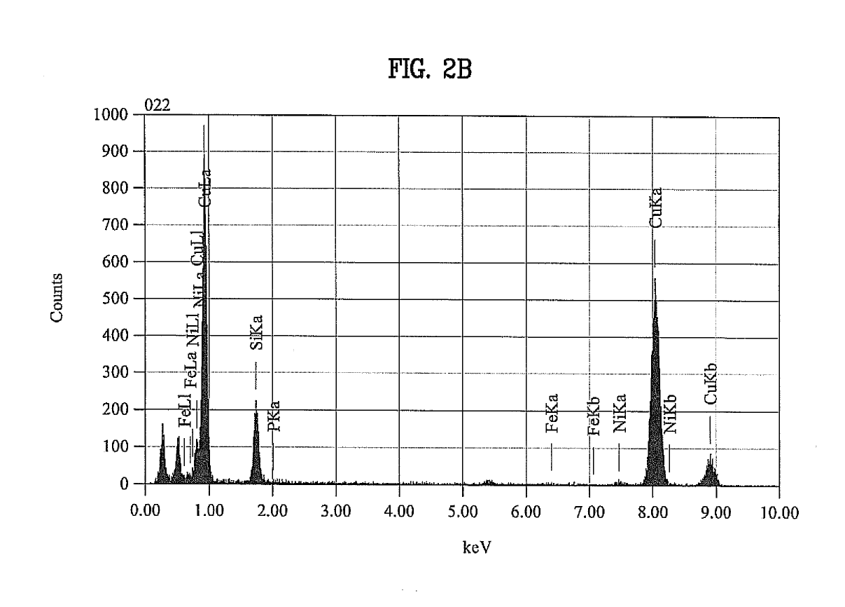

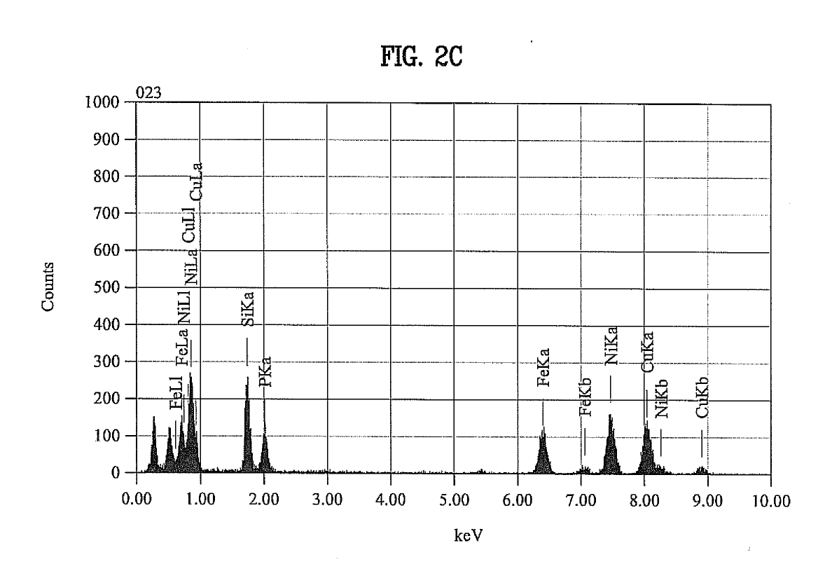

FIG. 1A is a transmission electron microscope (TEM) image showing a strip sample prepared using a Cu alloy material according to the present invention prepared according to composition of No. 3 shown in Table 2 (Cu-3.0Ni-0.7Si-0.05P-0.3Mn);

FIGS. 1B to 1E respectively illustrate energy dispersive spectroscopy (EDS) analysis peaks of points 1 to 4 illustrated in FIG. 1A;

FIG. 2A is a TEM image showing a strip sample formed of a Cu alloy material according to the present invention prepared according to composition of No. 12 shown in Table 2 (Cu-3.0Ni-0.7Si-0.05P-0.3Fe); and

FIGS. 2B and 2C respectively illustrate EDS analysis peaks of points 1 and 2 illustrated in FIG. 2A.

### DETAILED DESCRIPTION OF AN EXEMPLARY EMBODIMENT

Reference will now be made in detail to the preferred embodiments of the present invention, examples of which are illustrated in the accompanying drawings. Wherever possible, the same reference numbers will be used throughout the drawings to refer to the same or like parts.

Copper (Cu) Alloy Material According to the Present Invention

The present invention provides a Cu alloy material for electrical and electronic components in which impurities adversely affecting electrical conductivity are effectively controlled.

The Cu alloy material for electrical and electronic components includes 0.5 to 4.0 wt % of nickel (Ni), 0.1 to 1.0 wt % of silicon (Si), 0.02 to 0.2 wt % of phosphorus (P), the remainder of Cu, and an inevitable impurity, in which the inevitable impurity includes at least one transition metal selected from the group consisting of titanium (Ti), cobalt (Co), iron (Fe), manganese (Mn), chromium (Cr), niobium (Nb), vanadium (V), zirconium (Zr), and hafnium (Hf). A total amount of the impurity is within 10% of the sum of the amounts of Ni and Si. The Cu alloy material includes a compound in the form of Ni—Si—P—X, wherein X is the impurity.

(1) Ni and Si

To achieve properties sought by the present invention, the amount of Ni is between 0.5 and 4.0 wt % based on the finally obtained Cu alloy material. When the amount of Ni is less than 0.5 wt % based on the finally obtained Cu alloy material, strength needed for use in semiconductor lead frames or connectors is not achieved. On the other hand, when the amount of Ni exceeds 4.0 wt %, a coarse Ni—Si compound in an ingot state is formed through reaction with other impurities and thus defects such as cracks occur due to differences in ductility between the coarse Ni—Si compound and a matrix structure during hot rolling.

Si may be generally included in the Cu alloy material in an amount ratio of Ni:Si of 5:1 to 4:1, and the Cu alloy material includes 0.1 to 1.0 wt % of Si. When the amount of Si is too small, a desired precipitate may not be sufficiently formed. On the other hand, when the amount of Si is too great, Si may have an adverse effect during formation of a coarse precipitate and hot rolling and have a great effect on platability.

When the Cu alloy material is subjected to aging treatment, Ni and Si form Ni—Si-based precipitates, mainly, micron-scale Ni₂Si precipitates, which are a main strengthening mechanism, and thus, strength and electrical conductivity of the matrix is significantly enhanced.

(2) P

P is a vital element that serves as a deoxidizer and strengthens precipitation and is charged as 5 wt % or more of a mother alloy in the form of P—Cu when melted to form a stable precipitate in the form of Ni₃P during aging (See [Journal of Materials Science, vol 21. 1986. pp. 1357-1362], the entire contents of which are incorporated herein by reference). In addition, P forms a compound in the form of Mg₂Si, Mg₃P₂, or MgP₄, which contributes to enhancement of strengthening effects (See Korean Patent Registration No.: 10-0082046-0000, the entire contents of which are incorporated herein by reference).

P enhances strength according to formation of a precipitate in the form of Ni₃P, Ni₅P₂, Fe₃P, Mg₃P₂, or MgP₄ and serves as a mediator for combining other inevitable impurity elements, in particular, transition metals such as cobalt (Co), iron (Fe), manganese (Mn), chromium (Cr), niobium (Nb), vanadium (V), zirconium (Zr), and hafnium (Hf) (hereinafter defined as other impurities). The above-described other impurity elements are inevitably present in the Cu alloy material according to purity of a material such as scrap copper or electrolytic copper used as an alloy raw material. That is, P chemically combines the Ni—Si-based precipitate with the other impurities to form a compound in the form of Ni—Si—P—X.

Accordingly, the other impurities are precipitated and separated from a Cu matrix structure, whereby reduction in electrical conductivity due to the impurities may be minimized and enhancing effects of the precipitate on strength properties may further be anticipated.

(3) Impurity (Ti, Co, Fe, Mn, Cr, Nb, V, Zr, or Hf)

The impurity used in the present invention may be at least one transition metal selected from the group consisting of Ti, Co, Fe, Mn, Cr, Nb, V, Zr, and Hf. The impurity is precipitated in the form of Ni—Si—P—X (wherein, X is the above-described impurity) from the matrix by binding energy with P in precipitation treatment.

Meanwhile, preconditions for combining the impurity with the Ni—Si-based precipitate using P as a mediator are that an absolute value of binding energy of the impurity and P has to be greater than that of binding energy of the other main alloy elements and P. With regards thereto, binding energy of each transition metal included in the Cu alloy material according to the present invention as an impurity is higher than that of Ni, which is the main alloy element, as shown in Table 1 below (an excerpt from [Cohesion in metals, 1988, F. R. de Boer et al., North-Holl and Physics Publishing], the entire contents of which are incorporated herein by reference). Thus, when the amount of the transition metal as an impurity is much smaller than that of the main alloy elements, precipitation of the main alloy elements may be assisted rather than being inhibited.

TABLE 1

| | Ti | Co | Fe | Mn | Cr | Nb | V | Zr | Hf | Ni |
|---|---|---|---|---|---|---|---|---|---|---|
| Binding energy | −162 | −63 | −70 | −95 | −85 | −148 | −117 | −204 | −189 | −61 |
| with P ΔH | | | | | | | | | | |
| (kJ/mol) | | | | | | | | | | |

*Ni₂Si binding energy = −32 kJ/mol

In addition, not to inhibit precipitation of the Ni—Si-based compound and to be precipitated in the form of a complex compound, the transition metal has to be present within a range that does not inhibit Ni—Si binding or Ni—Si—P binding. That is, binding energy between particular elements is proportional to a molar amount of each element and, for example, it has been analyzed that Zr—P binding energy is very high, i.e., −204 kJ/mol, but when a content of each element is small, Ni—Si—P is first formed and then the element Zr in the matrix combines therewith to form Ni—Si—P—Zr, rather than forming a third precipitate through combination between Zr and P (See Equation 1 below, an excerpt from [Cohesion in metals, 1988, F. R. de Boer et al., North-Holland Physics Publishing], the contents of which are incorporated herein by reference). Thus, when ΔH(Ni—Si—P)>>ΔH(X—P) (wherein, X is the above-described transition metal), a Ni—Si—P—X compound may be stably precipitated, and conditions satisfying the same may be obtained through comparative analysis of each binding energy. When a total amount (molar amount) of the transition metal as an impurity is 10% or less of the sum of the amounts of Ni and Si, precipitation of the Ni—Si-based compound is not inhibited and it has a positive effect on enhancing strength and thermal stability.

$$X - P binding energy = ( \frac{weight ( X )}{atomic weight ( X )} + \frac{weight ( P )}{atomic weight ( P )} ) \times {H}_{( X - P )}^{M} \qquad Equation 1$$

Thus, the total amount of the impurity is within 10% of the total sum of the amounts of Ni and Si.

The size (maximum particle diameter) of the formed precipitate does not exceed 1 μm. When the size (maximum particle diameter) of the formed precipitate exceeds 1 μm, it may adversely affect platability and bending formability.

(3) Mg

The Cu alloy material according to the present invention may further include Mg. In the Cu—Ni—Si—P alloy, Mg forms a compound in the form of Mg₂Si, Mg₃P₂, or MgP₄ and thus causes a higher strengthening effect, and Si and P are removed from the Cu alloy matrix, whereby thermal stability of a Si-plating layer plated on a surface of a Cu alloy substrate is significantly enhanced. When Mg is excessively added, however, electrical conductivity and ductility are deteriorated. Accordingly, the amount of Mg in the Cu alloy material may be 0.3 wt % or less.

(4) Ag

The Cu alloy material according to the present invention may further include Ag. When the amount of Ag in the Cu alloy material is 0.3 wt % or less, strength and thermal resistance properties are enhanced without reduction in electrical conductivity.

(5) Zn

The Cu alloy material according to the present invention may further include Zn. When the amount of Zn in the Cu alloy material is 1.0 wt % or less, electrical conductivity may not be significantly reduced and solid-solution strengthening effects are anticipated.

(6) Sn

Sn is an element having a very slow diffusion rate in a Cu matrix and when a large amount of Sn is added, problems such as Sn segregation may occur. When the amount of Sn in the Cu alloy material is 0.8 wt % or less, however, growth of the precipitate is inhibited and thus strength is enhanced.

(7) O and S

In the Cu alloy material, O and S are contained in electrolytic Cu in large amounts or remain as moisture on a surface of the scrap copper and as an oil form after rolling. These components are considerably removed through a deoxidation process, but complete removal thereof is very difficult. Conventionally, it is known that oxidation of Mg can be prevented when the amount of oxygen is 15 ppm or less (e.g., see Japanese Patent Laid-Open Publication No. hei 5-59468). In the prevent invention, however, a compound in the form of Ni—Si—P—X—O or Ni—Si—P—X—S may be precipitated using P as a mediator, and thus, the components O and S may be included therein in an amount of 0.5 wt % or less based on the total amount of the Cu alloy material. When the amount of O and S is within the above-described range, the Cu alloy material may be smoothly formed as a precipitate in the preparation method due to structural properties of the Cu alloy material according to the present invention.

Method of Preparing the Cu Alloy Material According to the Present Invention

The method of preparing the Cu alloy material according to the present invention is as follows:

obtaining an ingot by melting and casting the corresponding metal components according to the above-described metal component composition,

hot-working the ingot at a temperature between 750 and 1050° C. and water-cooling the hot-worked ingot,

cold-working the obtained product,

repeatedly annealing and air-cooling the cold-worked product at a temperature between 300 and 600° C. for 1 to 15 hours, and

continuously performing stress-relieving treatment on the obtained product at a temperature between 300 and 700° C. for 10 to 600 seconds.

In the casting process, a molten metal is prepared in a ratio of components of the Cu alloy material for electrical and electronic components according to the present invention. That is, the prepared molten metal may include 0.5 to 4.0 wt % of Ni, 0.1 to 1.0 wt % of Si, 0.02 to 0.2 wt % of P, the remainder of Cu, the above-described solid-solution strengthening element in a small amount to enhance strength, and other inevitable impurities through reducing scrap copper, electrolytic copper, or other copper scrap metals with low purity in the preparation method. The elements have already been described in the description of the Cu alloy material for electrical and electronic components according to the present invention and thus a detailed description thereof will be omitted here.

Meanwhile, effects thereof may be maximized according to changes in P addition method. In the present invention, as a method of adding P to the molten metal, Cu, Ni, Si and optionally Zn, Mg, Ag, or a combination thereof, as solid-solution strengthening elements, may be introduced in a melting furnace or a holding furnace and completely melted, Cu—P in the form of a master alloy (5 wt % or more of P) is finally added thereto, and then melt treatment may be performed thereon until solidification is completed so that the amount of P is up to 0.2 wt %.

In the related art, P is added in a melting process and introduction of raw materials is mainly performed by, in a descending order, melting scrap, Ni, and Cu, P deoxidation, addition of main alloy elements (Si, Ni, Sn, and the like), and final addition of an oxidative alloy element (Mg, Cr, or the like). In this order of addition, however, phosphorus copper in the form of a master alloy (Cu—P), such as Cu-5 wt % P, Cu-10 wt % P, Cu-15 wt % P, or Cu-30 wt % P is used due to strong oxidizability of P. In terms of the order of charging raw materials, in general high-frequency and medium-frequency melting furnaces, generally, Ni having a high melting point and electrolytic copper or scrap copper as a raw material are melted, and then P is added thereto to remove oxygen remaining on a surface of the electrolytic copper or scrap copper. This operation is performed to minimize the amount of oxygen remaining on the surface of the electrolytic copper or scrap copper, to secure fluidity of the molten metal, and to inhibit oxidation of Mg, Cr, and the like, which are strongly oxidative alloy elements. In the melting process, as desired, oxidation of the surface of the molten metal may be minimized using charcoal or a commercially available deoxidizer (C—B—Al—Mg-etc) and molten metal coating material (borax-based compound such as Na₂B₄O₇). In another embodiment, in the melting process, as desired, degassing treatment and killing treatment (including removal of surface slag, molten metal holding, and the like) may be performed so that oxides and gases in the molten metal float onto the surface of the molten metal, whereby soundness of the molten metal is obtained. In addition, there is a method of adding Ni after melting electrolytic copper, but this method takes much time for sufficient induction power of a furnace in order to melt Ni having a high melting point and thus is avoided in practice. In this case, by adding P before addition of all the alloy elements, oxygen remaining in the molten metal is removed and thus oxidation of the other raw materials, i.e., Si, Mg, Cr, Ti, and Mn, may be inhibited.

Meanwhile, in a shaft type melting furnace for a continuous casting process, a Cu molten metal is provided to a holding furnace in a state of containing a minimum amount of oxygen and thus a certain amount of phosphorus copper (Cu—P) as a master alloy is added in the holding furnace using a vibrator before addition of the Cu molten metal into the holding furnace or a certain amount of the phosphorus copper (Cu—P) as a master alloy is added to a molten metal ejector through wire feeding and diffused and contained in the molten metal before the molten metal is introduced into a caster.

In the method of preparing the Cu alloy material for electrical and electronic components according to the present invention, the existing melting process is performed, followed by addition of P after melting oxidative alloy elements (e.g., Mg, Cr, Mn, Ge, Nb, Al, and the like), whereby casting detects caused by oxides prior to the casting process are minimized, and formation of the Ni—Si—P-X precipitate is induced in the subsequent precipitation treatment process. In the present invention, P may be added several times in the middle of manufacturing processes as desired to cause deoxidation and secure fluidity of the molten metal in the existing metal process, but, to maximize effects by addition of P, it is necessary to add P at least once in the last step of the melting process. For example, P may be added according to the following order: melting Cu at a temperature of 1200° C. or more→addition of a half of the total amount of P added for deoxidation (removal of oxygen)→addition of Ni and Si, which are precipitation hardening elements→addition of a solid-solution strengthening element (Zn, Mg, Ag, or Sn)→addition of the other half of the total amount of P to finally remove the remaining oxygen and serve as a mediator for removal of impurities→casting or continuous casting.

When other alloy elements are not added, P may be generally added by dividing the total amount of P added by two, due to strongly oxidative P, as a general method for deoxidation effects and adjustment of the amounts of the components using P, but the amount of P added may vary according to working conditions. The addition of P after melting Cu serves to remove oxygen contained in the electrolytic copper or scrap copper, and addition of P after melting Ni and Si serves to secure P as a residual component, in which P combines with O, S and an impurity (Ti, Co, Fe, Mn, Cr, Nb, V, Cd, Zr, Hf, or a combination thereof) inevitably contained during treatment at a temperature between 300 and 600° C. for 1 to 15 hours in the manufacturing processes to be precipitated in the form of Ni—Si—P—X (O, S and the impurity) and, accordingly, reduction in electrical conductivity due to the impurities is prevented. In this regard, as described above, preconditions are that an absolute value of binding energy of the impurity and P has to be greater than that of Ni—P binding energy, as shown in Table 1 above.

Subsequently, the obtained product, i.e., the ingot, is subjected to hot working at a temperature between 750 and 1050° C. for 30 minutes to 10 hours and to water cooling. Hot working includes hot rolling, hot forging, hot extrusion, and plastic working of the Cu alloy material by heat, such as deformation using a hammer or the like after heating and may be appropriately performed by those skilled in the art according to type of the final product and properties required.

Thereafter, the obtained product is subjected to cold working to a desired thickness. In this regard, workability may be appropriately selected by those skilled in the art according to the thickness of the final product.

Subsequently, the cold-worked product is repeatedly annealed and air-cooled at a temperature between 300 and 600° C. for 1 to 15 hours. The annealing and air-cooling processes may be performed by the number of times of repetition, appropriately selected by those skilled in the art according to type of the final product and properties required.

Lastly, the obtained product is subjected to final cold working, followed by stress-relieving treatment at a temperature between 300 and 700° C. for 10 to 600 seconds. Stress-relieving treatment means an annealing process whereby stress applied on the product obtained through the above-described steps during the steps is relieved by heat.

The Cu alloy material for electrical and electronic components prepared using the above-described preparation method has high strength, high electrical conductivity, and high thermal stability. That is, even though the precipitation hardening-type Cu alloy material contains an impurity in the form of a transition metal, the precipitation hardening-type Cu alloy material has a higher electrical conductivity, i.e., 1 to 5%, a tensile strength of up to 40 MPa, and a softening resistance temperature of up to 50° C., when compared to a Cu alloy material to which P is not added. Such effects are obtained since the transition metal included as an impurity in the Cu alloy material is precipitated in the form of Ni—Si—P—X (wherein, X is an impurity) using P as a mediator.

As desired, the Cu alloy material may be prepared in the form of a strip, a stick, and a tube. More particularly, the Cu alloy material may be prepared in the form of a strip having a thickness of 0.06 to 1.2 mm.

Therefore, the Cu alloy material obtained using the preparation method according to the present invention may be widely used in electrical and electronic applications and, for example, may be applied to signal transmission and electrical contact materials for connectors for semiconductor lead frames and automobiles, terminals, relays, switches, and the like.

### EXAMPLES

### Preparation of Cu Alloy Material According to Examples and Comparative Examples

To verify changes in electrical conductivity according to P addition methods, 5 kg of electrolytic copper was melted in a graphite crucible having an inner diameter of 100 mm using a high-frequency induction furnace and 3.0 wt % of Ni and 0.7 wt % of Si were added thereto and melted therein. To verify effects of solid-solution strengthening alloy elements and impurity alloy elements, Mg, Zn, Mn, Ti, Cr, Fe, and the like, which have high oxidizing ability, were finally melted in amounts between 0.1 and 0.3 wt %. Composition and amounts thereof are shown in Tables 2 and 3 below. In this regard, melting of each alloy element was performed at 1250° C., and then all the melted alloy elements were subjected to soothing at 1250° C. and kept for 5 to 10 minutes and the molten metal was injected into a graphite mold, thereby completing fabrication of an ingot having a thickness of 30 mm and a width of 70 mm.

In order for the obtained ingot to be prepared in the form of a strip, the ingot was hot-rolled at 980° C. and water-cooled, opposite surfaces of the ingot were subjected to milling to a depth of 0.3 to 0.6 mm to remove oxide scales, followed by cold working to a thickness of 0.35 mm, precipitation treatment at 460° C. for 5 hours, and removal of an oxide film on a surface of the obtained product, and the processes were repeated. After final cold working, the thickness of the Cu alloy material was about 0.2 mm, and the Cu alloy material was subjected to stress-relieving treatment at 550° C. for 50 seconds.

By varying compositions as shown in Table 2 below, strip samples according to a variety of examples and comparative examples were prepared. To evaluate the correlation between P and the presence of impurities that affects precipitation forms, physical properties, and electrical properties, strip samples consisting of various alloy groups according to Examples and Comparative Examples were prepared using a Cu-3.0Ni-0.7Si alloy and a Cu-1.0Ni-0.25Si alloy as representative compositions.

Mechanical and physical properties of the prepared strip samples were evaluated as follows.

### Experimental Example 1

### Measurement of Size, Composition and Number of Precipitates

A cross-section in a direction orthogonal to a rolling direction of each strip sample was subjected to mirror surface polishing using a suspension with diamond particles having a final diameter of 0.05 μm dispersed therein, an observation sample was prepared by chemical etching or using a replica method and then observed using a transmission electron microscope (TEM) at a magnification of ×6,000 to ×100,000, and the compositions of precipitates were confirmed by energy dispersive spectroscopy (EDS). Observation results of the sizes of precipitates are shown as the size (μm) of Ni—Si—P—X-based precipitates of Table 2 below.

### Experimental Example 2

### Evaluation of Mechanical and Physical Properties

1) Electrical Conductivity

Electrical resistances were measured using a 4-probe method that minimizes contact resistance, and a percentage (% IACS) of a ratio of electrical conductivity to a resistance value of standard heat-treated pure copper (volume resistivity: 1.7241 μΩcm) is shown in Tables 2 and 3 below.

2) Hardness

Hardness was measured using a Vickers hardness tester using KS B 0811:2003 (standard test method). Results are shown in Tables 2 and 3 below.

TABLE 2

| | | | Size of | | | | Softening resistance | |
|---|---|---|---|---|---|---|---|---|
| | | | Ni—Si—P—X | Electrical | Tensile | | temperature | |
| | P | Impurities | precipitate | conductivity | strength | Hardness | (° C., kept | |
| No. | (wt %) | (wt %) | (μm) | (% IACS) | (MPa) | (Hv, 1 kg) | for 30 min.) | remarks |
| 1 | 0 | 0 | <1.5 | 48.9 | 710 | 220 | 480 | Comparative |
| | | | | | | | | Example |
| 2 | 0 | 0.3 | <0.8 | 36.8 | 745 | 239 | 500 | Comparative |
| | | Mn | | | | | | Example |
| 3 | 0.05 | 0.3 | <0.8 | 40 | 751 | 247 | 550 | Example |
| | | Mn | | | | | | |
| 4 | 0 | 0 | <1.0 | 48.9 | 710 | 220 | 480 | Comparative |
| | | | | | | | | Example |
| 5 | 0 | 0.3 | <1.0 | 45 | 730 | 232 | 490 | Comparative |
| | | Ti | | | | | | Example |
| 6 | 0.1 | 0.3 | <1.0 | 49 | 770 | 253 | 530 | Example |
| | | Ti | | | | | | |
| 7 | 0 | 0 | <1.5 | 48.9 | 710 | 220 | 480 | Comparative |
| | | | | | | | | Example |
| 8 | 0 | 0.3 | <1.0 | 45.2 | 750 | 245 | 550 | Comparative |
| | | Cr | | | | | | Example |
| 9 | 0.05 | 0.3 | <1.0 | 48.3 | 775 | 255 | 590 | Example |
| | | Cr | | | | | | |
| 10 | 0 | 0 | <1.5 | 46.9 | 710 | 220 | 480 | Comparative |
| | | | | | | | | Example |
| 11 | 6 | 0.3 | <1.0 | 45.4 | 763 | 246 | 520 | Comparative |
| | | Fe | | | | | | Example |
| 12 | 0.05 | 0.3 | <1.0 | 47.6 | 768 | 251 | 570 | Example |
| | | Fe | | | | | | |

* reference alloy Cu—3.0Ni—0.7Si

TABLE 3

| | | | Size of | | | | Softening resistance | |
|---|---|---|---|---|---|---|---|---|
| | | | Ni—Si—P—X | Electrical | Tensile | | temperature | |
| | P | Impurities | precipitate | conductivity | strength | Hardness | (° C., kept | |
| No. | (wt %) | (wt %) | (μm) | (% IACS) | (MPa) | (Hv, 1 kg) | for 30 min.) | remarks |
| 13 | 0 | 0 | <1.0 | 52.1 | 440 | 135 | 350 | Comparative |
| | | | | | | | | Example |
| 14 | 0 | 0.1 | <1.0 | 48.5 | 454 | 140 | 360 | Comparative |
| | | Mn | | | | | | Example |
| 15 | 0.03 | 0.1 | <1.0 | 51.6 | 465 | 146 | 370 | Example |
| | | Mn | | | | | | |
| 16 | 0 | 0 | <1.0 | 52.1 | 440 | 135 | 350 | Comparative |
| | | | | | | | | Example |
| 17 | 0 | 0.1 | <1.0 | 47.3 | 436 | 131 | 330 | Comparative |
| | | Ti | | | | | | Example |
| 18 | 0.05 | 0.1 | <1.0 | 51.2 | 453 | 140 | 350 | Example |
| | | Ti | | | | | | |
| 19 | 0 | 0 | <1.0 | 52.1 | 440 | 135 | 350 | Comparative |
| | | | | | | | | Example |
| 20 | 0 | 0.1 | <1.0 | 48 | 467 | 147 | 380 | Comparative |
| | | Cr | | | | | | Example |
| 21 | 0.03 | 0.1 | <1.0 | 52 | 470 | 151 | 390 | Example |
| | | Cr | | | | | | |
| 22 | 0 | 0 | <1.0 | 52.1 | 440 | 135 | 350 | Comparative |
| | | | | | | | | Example |
| 23 | 0 | 0.1 | <1.0 | 48 | 467 | 147 | 380 | Comparative |
| | | Cr | | | | | | Example |
| 24 | 0.05 | 0.1 | <1.0 | 53 | 475 | 156 | 380 | Example |
| | | Fe | | | | | | |

* reference alloy Cu—1.0Ni—0.25Si

The size of all the Ni—Si—P—X-based precipitates according to the present invention shown in Tables 2 and 3 above was 1.0 μm or less.

In addition, the most important characteristic of the Cu alloy material according to the present invention is that although the Cu alloy material includes the impurity, the Cu alloy material has enhanced electrical conductivity, tensile strength and hardness by addition of P. That is, through comparison between results of Nos. 1 to 3 in Table 2 above, it is confirmed that No. 2 had a lower electrical conductivity than that of No. 1, due to addition of Mn as an impurity. However, from the results shown in Table 2, it can be confirmed that, when 0.05 wt % of P was added to the components of No. 2, the Cu alloy material had enhanced electrical conductivity, tensile strength and hardness. Such results are opposed to those known for changes due to addition of P to existing Cu alloys.

From results shown in Tables 2 and 3 above, it can be confirmed that the Cu alloy materials according to the present invention rather had an increased electrical conductivity, i.e., by approximately 2 to 4% IACS, although the Cu alloy materials include impurities and P and also exhibited partially increased tensile strength and hardness values when compared to Cu alloy materials to which impurities and P are not added. Such properties support the fact that P of the Ni—Si—P—X-based alloy serves as a mediator for formation of a precipitate of impurities and alloy elements to thus combine the impurities in a matrix with the alloy elements.

That is, P combines an Ni—Si precipitate that serves to enhance strength and softening resistance with impurities and thus strengthening of dispersion in the Cu alloy material is more smoothly performed, whereby the Cu alloy material according to the present invention has a higher softening resistance temperature than a Cu alloy material to which P is not added, which results in increased heat resistance.

In addition, in terms of raw material costs, when a Carson-based alloy is prepared, there are no difficulties in minimizing reduction in electrical conductivity and enhanced tensile strength and softening resistance properties without strict regulation of raw materials, due to addition of P, and thus, raw materials (including scrap) containing a relatively large amount of impurities may be applied, which results in decreased raw material costs.

Analysis results of TEM taken to verify the size and type of the Ni—Si—P—X-based precipitate in the Cu alloy material according to the present invention are illustrated in FIG. 1A, and EDS analysis results for points 1 to 4 illustrated in FIG. 1A are illustrated in FIGS. 1B to 1E.

From the results shown in FIG. 1A, it can be confirmed that a Ni—Si—P—Mn precipitate containing P was formed when Mn was present as an impurity, and composition analysis results are shown in Table 4 below.

In addition, kinds and composition analysis results of precipitates are illustrated in FIGS. 1B to 1E and Table 4. In Table 4, points 1, 2, 3 and 4 denote the points illustrated in FIG. 1A. As seen from Table 4 below, P was not observed in the matrix (point 1) and measurement thereof was impossible because a very small amount of P was added. By contrast, it can be confirmed that P serves as a mediator in the precipitates and was precipitated together with Mn, which is a transition metal.

TABLE 4

| Point | Cu | Ni | Si | P | Mn | Type |
|---|---|---|---|---|---|---|
| 1 | 91.8 | 0.39 | 7.81 | — | — | Matrix |
| 2 | 17.64 | 45.3 | 23.41 | 0.69 | 12.95 | Ni—Si—P—Mn |
| 3 | 17.89 | 47.32 | 20.15 | 0.66 | 13.97 | Ni—Si—P—Mn |
| 4 | 29.38 | 39.42 | 17.73 | 0.34 | 13.13 | Ni—Si—P—Mn |

FIG. 2A illustrates that a Ni—Si—P—Fe precipitate containing P is formed when Fe is present as an impurity. In addition, the size of the precipitate illustrated in FIG. 2A was 0.05 μm, and chemical composition thereof was 18.3Cu-33.3Ni-19.06Si-8.49P-20.86Fe according to Table 5 below.

TABLE 5

| Point | Cu | Ni | Si | P | Fe | Type |
|---|---|---|---|---|---|---|
| 1 | 88.31 | 1.39 | 10.28 | 0.02 | — | Matrix |
| 2 | 18.3 | 33.3 | 19.06 | 8.49 | 20.86 | Ni—Si—P—Fe |

From Table 5 above, it can be confirmed that the precipitate containing P and Fe as an impurity was observed.

As described above, it can be confirmed that the Ni—Si—P—X-based precipitate was formed according to addition of P, the size of the precipitate was 1.0 μm or less, and the precipitate had increased electrical conductivity, i.e., by approximately 1 to 5% IACS and was very effective in enhancing alloy strength.

As is apparent from the foregoing description, the present invention provides a Cu alloy material for electrical and electronic components in which impurities are effectively controlled and utilized and thus strength, thermal stability, and electrical conductivity most required for a material for electrical and electronic components are enhanced at a maximum level and a method of preparing the same.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A copper (Cu) alloy material for electrical and electronic components, comprising:
0.5 to 4.0 wt % of nickel (Ni), 0.1 to 1.0 wt % of silicon (Si), 0.02 to 0.2 wt % of phosphorus (P), the remainder of Cu, and an inevitable impurity.

2. The Cu alloy material according to claim 1, wherein the inevitable impurity comprises: at least one transition metal selected from the group consisting of titanium (Ti), cobalt (Co), iron (Fe), manganese (Mn), chromium (Cr), niobium (Nb), vanadium (V), zirconium (Zr), and hafnium (Hf), wherein the at least one transition metal chemically combines with a Ni—Si—P-based precipitate using P as a mediator to form a compound in the form of Ni—Si—P—X (wherein, X is the transition metal).

3. The Cu alloy material according to claim 1, wherein:
a total amount (wt %) of the inevitable impurity is within 10% of a sum of amounts of Ni and Si of the Cu alloy material.

4. The Cu alloy material according to claim 1, further comprising:
0.3 wt % or less of magnesium (Mg).

5. The Cu alloy material according to claim 1, further comprising 0.3 wt % or less of silver (Ag).

6. The Cu alloy material according to claim 1, further comprising 1.0 wt % or less of zinc (Zn).

7. The Cu alloy material according to claim 1, further comprising 0.8 wt % or less of tin (Sn).

8. The Cu alloy material according to claim 1, wherein:
a precipitate in the Cu alloy material has a size of 1 μm or less.

9. A method of preparing a Cu alloy material, the method comprising:
obtaining an ingot through melting and casting so as to have composition of 0.5 to 4.0 wt % of Ni, 0.1 to 1.0 wt % of Si, 0.02 to 0.2 wt % of P, the remainder of Cu, and an inevitable impurity;
hot-working the ingot at a temperature between 750 and 1050° C. and water-cooling the hot-worked ingot;
cold-working the product obtained through the hot-working to a desired thickness and repeatedly annealing and air-cooling the cold-worked product at a temperature between 300 and 600° C. for 1 to 15 hours; and
continuously stress removal heat-treating the product obtained through the cold-working at a temperature between 300 and 700° C. for 10 to 600 seconds.

10. The method according to claim 9, wherein:
a total amount (wt %) of the inevitable impurity is within 10% of a sum of amounts of Ni and Si of the Cu alloy material.

11. The method according to claim 9, wherein:
0.3 wt % or less of Mg is further added in the melting.

12. The method according to claim 9, wherein:
0.3 wt % or less of Ag is further added in the melting.

13. The method according to claim 9, wherein:
1.0 wt % or less of Zn is further added in the melting.

14. The method according to claim 9, wherein:
0.8 wt % or less of Sn is further added in the melting.

15. The method according to claim 9, wherein:
a precipitate formed in the Cu alloy material has a size of 1 μm or less.
